(19) United States
(12) Patent Application Publication
(10) Pub. No.: US 2011/0220390 A1
(43) Pub. Date: Sep. 15, 2011

(54) INSULATION WITH MICRO OXIDE PARTICLES FOR CABLE COMPONENTS

(75) Inventors: Gregg R. SZYLAKOWSKI, Loveland, OH (US); Alice C. ALBRINCK, Hebron, KY (US); Matthew S. MCLINN, Cincinnati, OH (US)

(73) Assignee: GENERAL CABLE TECHNOLOGIES CORPORATION, Highland Heights, KY (US)

(21) Appl. No.: 13/044,992

(22) Filed: Mar. 10, 2011

Related U.S. Application Data
(60) Provisional application No. 61/313,513, filed on Mar. 12, 2010.
(60) Provisional application No. 61/321,360, filed on Apr. 6, 2010.

(51) Int. Cl. H01B 7/295

(52) U.S. Cl. 174/113 R

(57) ABSTRACT

A cable that comprises at least a first pair of conductors. At least one of the conductors of the first pair of conductors has at least one layer of a composite insulation surrounding the conductor. The composite insulation includes insulating material and micro oxide particles adapted to provide an increase in the flame retardancy of the insulating material and an improvement in the electrical performance of the cable.

### RELATED APPLICATION

This application claims priority to U.S. Provisional Application Ser. No. 61/313,513, filed on Mar. 12, 2010, and U.S. Provisional Application Ser. No. 61/321,360, filed on Apr. 6, 2010, both entitled Insulation With Micro Oxide Particles and Cable Using The Same.

### FIELD OF THE INVENTION

The present invention relates to insulation with micro oxide particles used with cable and cable components for increasing the flame retardancy and the electrical performance of the cable.

### BACKGROUND OF THE INVENTION

Wire and cable insulation or coating or component compositions are normally quite flammable. As a result, they can pose a fire hazard in power plants, distribution areas, manholes, and buildings. Ignition can easily occur from overheating or arcing. Accordingly, various fire codes prohibit the use of cables, particularly in plenum applications, unless they pass certain smoke and flame retardancy tests. Therefore, flame retardants are generally used in wire and cable insulation and coatings to prevent electric sparks and subsequently to prevent the spread of fire along the cable.

Flame retardants, such as halogenated additives (compounds based on fluorine, chlorine or bromine) or halogenated polymers, such as chlorosulfonated polyethylene, neoprene, polyvinyl chloride, or the like, are commonly used in wire and cable insulation or coating compositions. Both halogenated additives and halogenated polymers are capable of giving fire-resistant properties to the polymer that forms the coating. Halogens, however, have a drawback in that the gases evolved (i.e. hydrogen chloride, hydrogen fluoride and hydrogen bromide) during burning, or even merely overheating, are corrosive as well as being toxic which is often limited by building codes or undesirable in some building overheating locations.

Another alternative for providing flame retardancy for wire and cable insulation is to use a metal hydroxide, which is inorganic, hydrated, and porous, as a filler in the polymer matrix. The metal hydroxide provides flame retardancy by a mechanism known as water of hydration. When the metal hydroxide is heated, water is evolved which effects a flame retardant action. A drawback of this system is that the metal hydroxide is polar, which absorbs moisture when the cable is exposed to a wet environment, resulting in a reduction in the electrical insulation properties of the coating composition. Use of metal hydroxides also limits processing temperature of the insulation.

Plenum rated cables are often made from various fluoropolymer materials, such as fluoroethylenepropylene (FEP), to provide flame retardancy. However, such fluoropolymer materials are expensive and significantly increase manufacturing costs. Also, FEP has been found to produce smoke under high or intense heat conditions which is often undesirable in building overheating locations.

Some fillers, such as calcium carbonates and kaolins, have been added to insulation; however such fillers are hydrophilic, increase the dissipation factor of the insulation, lower the dielectric constant of the insulation, thereby causing greater attenuation and delay skew. Delay is the time it takes a signal to travel the length of a pair. Delay skew is the difference between the longest and shortest delay among the pairs in the cable. Other fillers, such as glass, have been attempted; however the glass contains large amounts of sodium sulfate, sodium chloride, boron, iron and/or calcium that increase the insulation's dissipation factor. When the dissipation factor of the insulation is increased, the dielectric constant of the insulation is lower, thereby causing greater attenuation and delay skew. This increase in dissipation factor of the insulation cause greater attenuation of the signal along the length of the transmission line. Multiplatlet clays that are treated with ionic or cationic exfoliating agents have also been added to insulation, however such additives cause undesirable dielectric properties, they impart stiffness when cables are usually desired to be flexible, and their high surface areas cause undesirable rheological properties, such as increased viscosity, thereby limiting the amounts that can be added to the insulation.

### SUMMARY OF THE INVENTION

According to an exemplary embodiment, the present invention provides a cable that includes at least a first pair of conductors where at least one of the conductors of the first pair of conductors has at least one layer of a composite insulation surrounding the conductor. The composite insulation includes insulating material and micro oxide particles adapted to increase the flame retardancy or electrical properties of the insulation material. The conductors of the first pair of conductors may be twisted together.

According to another embodiment, the present invention provides a data cable that comprises at least a first pair of conductors. The first pair of conductors are twisted together. At least one of the conductors of the first pair of conductors has at least one layer of a composite insulation surrounding the conductor. The composite insulation includes insulating material and micro oxide particles adapted to provide an increase in the flame retardancy of the insulating material and an improvement in the electrical performance of the cable.

In one embodiment, the micro oxide particles are silicon dioxide. The composite of the invention can advantageously be used on power, data, communication, control, safety, transit, military, automotive, shipboard or other types of cable.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cross sectional view of a cable in accordance with an exemplary embodiment of the present invention; and

FIG. 2 is a cross section view of conductor pairs with more than one layer of insulation in accordance with an exemplary embodiment of the present invention; and

FIG. 3 is a graph of the increase in the viscosity of the insulation as micro oxide particles are added according to an exemplary embodiment of the present invention.

### DETAILED DESCRIPTION OF THE INVENTION

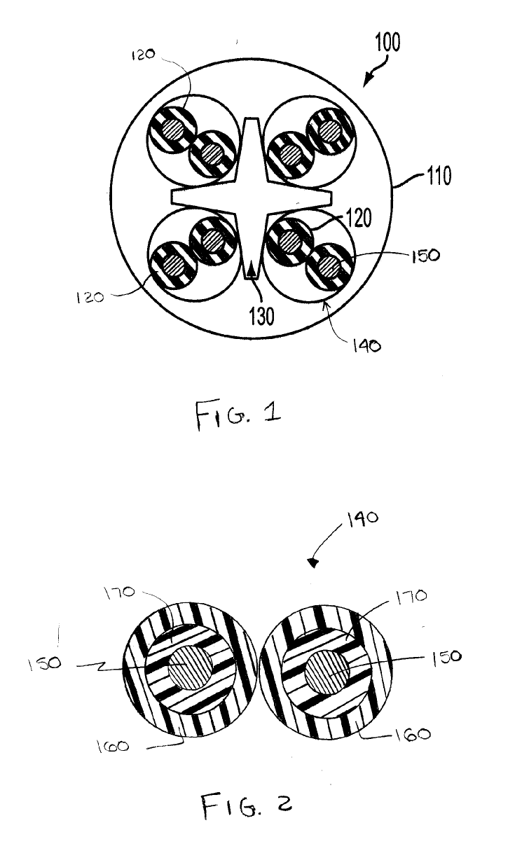

Referring to FIGS. 1 and 2, the present invention generally relates to a composite insulation for cable and its components that includes added non-porous micro oxide particles to improve the flame retardancy and electrical performance characteristics of the cable while also reducing costs. For example, with the addition of the non-porous micro oxide particles to the insulation, the insulation has (a) a decreased melt flow rate that contributes to a reduction in dripping, i.e. the melt flow index is decreased by up to about 100%, preferably about 3-50%, thereby decreasing the risk of flame spread and exhibiting less smoke when exposed to flame; (b) an increased dielectric constant by about 2-50%, and preferably 3-30%, thereby refining electrical performance; (c) an increased viscosity by 3-100%, preferably by about 3-30%, which improves and simplifies extruding; (d) preferably about 30-100% less transparency so that less, if any, coloring agent is required, to make the insulating material, cable jacket, bedding or other cable component opaque, and also produces brighter colors; and (e) increased charring by preferably about 3-30%, which results in more char and less burned or melted material which would give off smoke and chemicals. By adding micro oxide particles in the insulation, such as FEP for example, less FEP is required to achieve the same or better burn characteristics as conventional cable using only fluoropolymers. Alternatively, the micro oxide particles may be added to less expensive materials, such as polyethylene, to improve flame retardancy and electrical properties, and to reduce smoke generation.

Regarding the increased dielectric constant, the dielectric constant of an insulating compound considerably affects how that insulated wire or conductor and the resulting pair behaves electrically. FEP or fluorinated ethylene propylene, for example is not flammable, but instead drips and exudes smoke. When a cable containing FEP is subjected to the NFPA 262 test the dripping results in smoking material at the bottom of the chamber causing the optical density to increase. It has been demonstrated that higher melt flow FEP exhibits more dripping than lower melt flow FEP. FEP is excellent for use as a dielectric as it has an excellent dielectric constant of 2.1 and dissipation factor of 0.0005. Its low dielectric constant is essentially constant throughout various frequencies. FEP has excellent resistance to thermal and oxidative aging. FEP is considered to be one of the most chemical resistant polymers. FEP has a continuously effective usable temperature range from about −200° C. to +200° C. Its boundaries inherently set the electrical limits for two important electrical characteristics in a cable: capacitance and velocity of propagation. Capacitance is affected in that increasing the dielectric constant of the insulation material, such as by mixing FEP and the micro oxide particles, such as spherically-shaped amorphous silicon dioxide micro particles, with respect to virgin FEP, increases its conductor pair's capacitance. See TABLE 1 below. This is advantageous where the insulation diameters are fixed, impedance can be optimized by using an insulation material with a favorable dielectric constant, as impedance is very closely related to its capacitance. Secondly, a pair's dielectric constant affects the velocity of propagation of its electrical signal. By increasing the dielectric constant of the insulation material, such as by mixing FEP and the micro oxide particles/silicon dioxide with respect to virgin FEP, the resulting pair comparably slows down the transmitted signal. This phenomenon is advantageous in the case of a design of a cable with two different insulation types because it brings the delay skew of the cable closer together. This has been a restrictive constraint in the design of prior art cables.

TABLE 1

| | | | Dielectric | Dissipation |
|---|---|---|---|---|
| Sample ID | Frequency | | Constant | Factor |
| 0% Sidistar/100% FEP | 1 | kHz | 2.039 | 0.00222 |
| | 1 | MHz | 2.038 | 0.0004 |
| | 10 | MHz | 2.031 | 0.00252 |
| 5% Sidistar/95% FEP | 1 | kHz | 2.109 | 0.00189 |
| | 1 | MHz | 2.105 | 0.00078 |
| | 10 | MHz | 2.099 | 0.00249 |
| 10% Sidistar/90% FEP | 1 | kHz | 2.185 | 0.00236 |
| | 1 | MHz | 2.18 | 0.00079 |
| | 10 | MHz | 2.173 | 0.00274 |
| 15% Sidistar/85% FEP | 1 | kHz | 2.268 | 0.00258 |
| | 1 | MHz | 2.26 | 0.00102 |
| | 10 | MHz | 2.254 | 0.00285 |
| 20% Sidistar/80% FEP | 1 | kHz | 2.353 | 0.00275 |
| | 1 | MHz | 2.343 | 0.00111 |
| | 10 | MHz | 2.338 | 0.00262 |
| 25% Sidistar/75% FEP | 1 | kHz | 2.441 | 0.00303 |
| | 1 | MHz | 2.428 | 0.00119 |
| | 10 | MHz | 2.423 | 0.0017 |

The amorphous silicon dioxide was added into high density polyethylene (HDPE) at various loading levels (5%, 10%, 15%, 20% and 25%). TABLE 2 shows the resulting materials and their dielectric and dissipation characteristics. As the silicon dioxide loading level increases, so does the dielectric constant across all tested frequencies, although by a lower rate than it did in FEP. The dissipation factor is also fairly consistent among all loading levels. In addition to electrical properties, observations were made to the behavior of the samples as they were burned. With the addition of silicon dioxide to the HDPE, the flame spread traveled at a slower rate as the percentage of silicon dioxide increased. The materials also had reduced dripping as compared to the standard material. It is preferred that a cable be manufactured using a 25% loading of silicon dioxide into HDPE.

TABLE 2

| | | | Dielectric | Dissipation |
|---|---|---|---|---|
| Loading Percentage | Frequency | | Constant | Factor |
| 0% Sidistar/100% HDPE | 1 | kHz | 2.296 | 0.00326 |
| | 1 | MHz | 2.313 | 0.00127 |
| | 10 | MHz | 2.300 | 0.06410 |
| 5% Sidistar/95% HDPE | 1 | kHz | 2.325 | 0.00346 |
| | 1 | MHz | 2.343 | 0.00155 |
| | 10 | MHz | 2.329 | 0.06560 |
| 10% Sidistar/90% HDPE | 1 | kHz | 2.353 | 0.00347 |
| | 1 | MHz | 2.373 | 0.00125 |
| | 10 | MHz | 2.357 | 0.06750 |
| 15% Sidistar/85% HDPE | 1 | kHz | 2.389 | 0.00299 |
| | 1 | MHz | 2.404 | 0.00119 |
| | 10 | MHz | 2.391 | 0.05640 |
| 20% Sidistar/80% HDPE | 1 | kHz | 2.425 | 0.00361 |
| | 1 | MHz | 2.443 | 0.00162 |
| | 10 | MHz | 2.428 | 0.06510 |
| 25% Sidistar/75% HDPE | 1 | kHz | 2.459 | 0.00322 |
| | 1 | MHz | 2.474 | 0.00155 |
| | 10 | MHz | 2.461 | 0.06000 |

The amorphous silicon dioxide was added into ethylene vinyl acetate (EVA) at various loading levels (5%, 10%, 15%, 20% and 25%). TABLE 3 shows the resulting materials and their dielectric and dissipation characteristics.

TABLE 3

| | | | Dielectric | Dissipation |
|---|---|---|---|---|
| Loading Percentage | Frequency | | Constant | Factor |
| 0% Sidistar/100% | 1 | kHz | 2.903 | 0.0042 |
| EVA | 1 | MHz | 2.703 | 0.0345 |
| | 10 | MHz | 2.530 | 0.0387 |
| 10% Sidistar/90% | 1 | kHz | 2.927 | 0.0009 |
| EVA | 1 | MHz | 2.738 | 0.0322 |
| | 10 | MHz | 2.577 | 0.0356 |
| 20% Sidistar/80% | 1 | kHz | 3.031 | 0.0075 |
| EVA | 1 | MHz | 2.826 | 0.0307 |
| | 10 | MHz | 2.661 | 0.0345 |
| 30% Sidistar/70% | 1 | kHz | 3.042 | 0.0077 |
| EVA | 1 | MHz | 2.858 | 0.0276 |
| | 10 | MHz | 2.714 | 0.0306 |
| 40% Sidistar/60% | 1 | kHz | 3.159 | 0.0091 |
| EVA | 1 | MHz | 2.967 | 0.0261 |
| | 10 | MHz | 2.827 | 0.0288 |
| 50% Sidistar/50% | 1 | kHz | 2.977 | 0.0111 |
| EVA | 1 | MHz | 3.180 | 0.0235 |
| | 10 | MHz | 2.954 | 0.0275 |
| 60% Sidistar/40% | 1 | kHz | 2.985 | 0.0117 |
| EVA | 1 | MHz | 3.268 | 0.0193 |
| | 10 | MHz | 3.046 | 0.0220 |

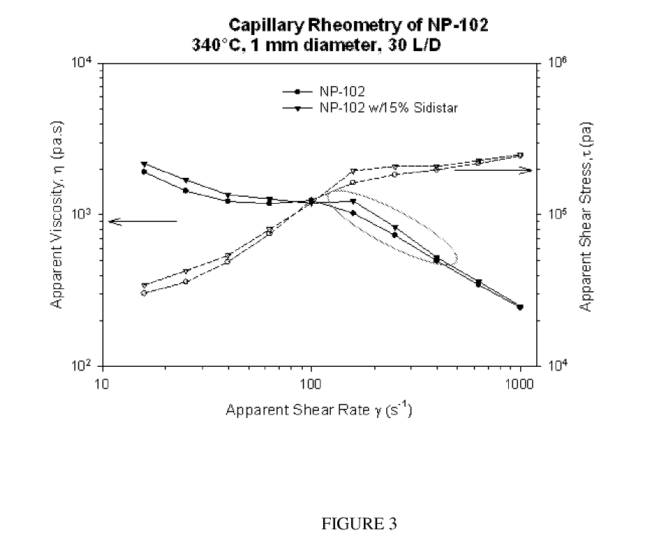

The increased viscosity resulting from adding the micro oxide particles to the insulation, as seen in the graph of FIG. 3, improves the processing characteristics of fluoropolymers and other pseudo plastic polymers during the extrusion process. Tip and die drool are minimized in fluoropolymers and other polymers utilized in the invention. Inherent fluoropolymer processing issues, such as disruptions in consistent material flow (commonly referred to as cone pulsations), result in knots or lumps (diameter fluctuations). FEP, for example, exhibits strongly pseudo plastic behavior making it difficult to extrude at higher speeds and higher shear rates. Low pressure in the die causes instability in extrusion and uneven wall thickness, cone pulsations, knots or lumps. The composition of the invention and its resulting increased viscosity minimizes flow disruptions and the associated defects. The increased viscosity is about 3 -100%. The exact amount of viscosity increase desired will depend on the viscosity or MFi of the polymer used. Lower MFi, higher viscosity polymers may be used, however such polymers may be higher in cost, exhibit less shear thinning, be highly viscoelastic, cause breaks in the insulation or have les desirable dielectric properties. The invention allows selection of the optimum polymer and the ability to tailor its viscosity. It permits the ability to utilize pressure tooling versus tube tooling to increase line speeds or manufacturing rates.

According to an exemplary embodiment of the invention, the micro oxide particles are oxides of a non-ionic, i.e. without a positive or negative ionic valence, cannot form an ionic bond, mineral or metal (element). Preferably the particles have a low surface area that impart improved dielectric, rheological, and fire resistance properties. The surface area of the micro oxide particles is preferably about 10-40 m²/g. Preferred oxides include Silicon, Aluminum, Magnesium and their double oxides. Zn and Fe oxides may also be suitable for some embodiments of the invention. Other oxides are envisioned to function in the invention but may not yet be available in the micro form described in the invention. Also, the micro oxide particles are preferably solid non porous amorphous particles, i.e. not crystalline material. The particle size of the micro oxide particles may be less than 0.300 μm, and is preferably in the range of 0.100-0.300 μm. The concentration of the micro oxide particles may be about 1 to 80% by weight of the insulation, and is preferably about 2-50%, and most preferred about 3-25%.

A preferred micro oxide particle is SIDISTAR® T 120, made by Elkem Silicon Materials, which is a spherically-shaped amorphous silicon dioxide additive designed for polymer applications. The average primary particle size of SIDISTAR® T 120 is 150 nm. Depending on the selected polymer, the SIDISTAR® T120 additive provides increased flame retardancy, greater stiffness, improved melt flow, improved surface finish, improved melt strength, improved dryblend flow, impact strength, and lower cost. In the mixing process, SIDISTAR® T120 improves the dispersion of all compound ingredients, providing well-balanced physical properties in the final insulation. Because it is dispersed as primarily spherical particles, it reduces internal friction and allows higher extrusion or injection speed as the result of better melt flow and therefore significant cost savings. Dispersion down to primary particles within the matrix enables a very fine cell formation, resulting in a reduction of high molecular weight processing aid and therefore much reduced raw material costs. Table 4 below provides the product specification of SIDISTAR® T 120.

TABLE 4

| Properties | Unit | Limits |
|---|---|---|
| SiO₂ | % | 96.0-99.0 |
| (Silicon dioxide, amorphous) | | |
| C (Carbon) | % | ≦0.20 |
| Fe₂O₃ | % | ≦0.25 |
| (Iron oxide) | | |
| H₂O | % | ≦0.8 |
| Loss on Ignition | % | ≦0.60 |
| (L.O.I.) @ 950° C. | | |
| Coarse Particles | % | ≦0.10 |
| (325 mesh) | | |
| pH-value | | 7.0-9.0 |
| Bulk Density | kg/m³ | 400-700 |
| Specific Surface Area | m²/g | 20 |
| (BET) | | |
| L-value | % | ≧89.5 |
| Median particle size | μm | 0.15 |
| Density | g/cm³ | 2.2 |

Other materials, such as silica fume, may be used as the micro oxide particles. Silica fume is also called microsilica Silica and is a byproduct in the reduction of high-purity quartz with coke in electric arc furnaces during the production of silicon and ferrosilicon. Silica fume consists of fine vitreous particles with a surface area of about 20 m²/g, with particles approximately 0.150 mm (micro meters) in diameter. The silica fume improves reology characteristics of the composite insulation.

Any polymer or thermoplastic known in the cable art may be used as the main component of the composite insulation to which the micro oxide particles may be added. For example, the insulation may be polyolefin, polyester, fluoropolymer, Halar, PTFE, PVC, and the like.

The polyethylene may be of the various types known in the art. Low density polyethylene (“LDPE”) can be prepared at high pressure using free radical initiators, or in gas phase processes using Ziegler-Natta or vanadium catalysts, and typically has a density in the range of 0.914-0.940 g/cm³. LDPE is also known as “branched” or “heterogeneously branched” polyethylene because of the relatively large number of long chain branches extending from the main polymer backbone. To reduce the density of such high density polyethylene resins below the range of densities that are normally produced in such processes, another alpha-olefin or co-monomer, may be copolymerized with the ethylene. If enough co-monomer is added to the chain to bring the density down to 0.912-0.939 gram/cc, then such products are known as linear, low density polyethylene copolymers. Because of the difference of the structure of the polymer chains, branched low density and linear, low density polyethylene have different properties even though their densities may be similar.

It will be understood that the term “linear low density polyethylene” is meant to include copolymers of ethylene and at least one alpha-olefin comonomer. The term includes copolymers, terpolymers, and the like. Linear low density polyethylenes are generally copolymers of ethylene and alpha-olefins, such as propene, butene, 4-methyl-pentene, hexene, octene and decene.

Polyethylene in the same density range, i.e., 0.916 to 0.940 g/cm³, which is linear and does not contain long chain branching may also be used. This “linear low density polyethylene” (“LLDPE”) can be produced with conventional Ziegler-Natta catalysts or with metallocene catalysts. Relatively higher density LDPE, typically in the range of 0.928 to 0.940 g/cm³, is sometimes referred to as medium density polyethylene (“MDPE”), may also be used. Linear low density polyethylene copolymers may be prepared utilizing the process, for example, as described in U.S. Pat. Nos. 3,645,992 and 4,011,382, the disclosures of which are incorporated herein by reference. The co-monomer which is copolymerized with the polyethylene is preferably an alpha-olefin having from about 3 up to about 10 carbon atoms. The density of the ethylene copolymer is primarily regulated by the amount of the co-monomer which is copolymerized with the ethylene. In the absence of the co-monomer, the ethylene would homopolymerize in the presence of a stereospecific catalyst to yield homopolymers having a density equal to or above 0.95. Thus, the addition of progressively larger amounts of the co-monomer to the ethylene monomer, results in a progressive lowering, in approximately a linear fashion, of the density of the resultant ethylene copolymer.

Low density polyethylenes suitable for use in the present invention include ethylene homopolymers and copolymers having up to 20% (w/w) of a comonomer, such as vinyl acetate, butyl acrylate and the like.

Polyethylenes may be used having still greater density, such as the high density polyethylenes (“HDPEs”), i.e., polyethylenes having densities greater than 0.940 g/cm³, and are generally prepared with Ziegler-Natta catalysts. High density polyethylene resins, i.e., resins having densities ranging up to about 0.970 gram/cc are manufactured at lower pressures and temperatures via heterogeneous ionic catalytic processes, for example, those utilizing an organometallic or a transition metal oxide catalyst. The products are linear, non-branched polyethylene.

Very low density polyethylene (“VLDPE”) may also be used. VLDPEs can be produced by a number of different processes yielding polymers with different properties, but can be generally described as polyethylenes having a density less than 0.916 g/cm³, typically 0.890 to 0.915 g/cm³ or 0.900 to 0.915 g/cm³.

U.S. Pat. Nos. 5,272,236 and 5,278,272, the subject matter of each of which is herein incorporated by reference, disclose polyethylenes termed “substantially linear ethylene polymers” (“SLEPs”). These SLEPs are characterized as having a polymer backbone substituted with about 0.01 long chain branches/1000 carbons to about 3 long chain branches/1000 carbons, more preferably from about 0.01 long chain branches/1000 carbons to about 1 long chain branches/1000 carbons, and especially from about 0.05 long chain branches/1000 carbons to about 1 long chain branches/1000 carbons. As used herein, a polymer with “long chain branching” is defined as one having a chain length of at least about 6 carbons, above which the length cannot be distinguished using ^{13C}NMR spectroscopy. It is further disclosed that the long chain branch can be as long as about the same length as the length of the polymer backbone. As used in the present invention, the term “linear” is applied to a polymer that has a linear backbone and does not have long chain branching; i.e., a “linear” polymer is one that does not have the long chain branches characteristic of an SLEP polymer.

Preferably the polyethylenes selected for use in the compositions of the present invention have melt indices in the range of from 1 to 30 g/600 s, more preferably 2 to 20 g/600 s. Preferably the low density polyethylenes have a density in the range of from 913 to 930 kg/m³, more preferably in the range of from 917 to 922 kg/m³.

The elastomer used in the base polymer in accordance with the present invention may also be selected from the group of polymers consisting of ethylene polymerized with at least one comonomer selected from the group consisting of C₃ to C₂₀ alpha-olefins and C₃ to C₂₀ polyenes. Generally, the alpha-olefins suitable for use in the invention contain in the range of about 3 to about 20 carbon atoms. Preferably, the alpha-olefins contain in the range of about 3 to about 16 carbon atoms, most preferably in the range of about 3 to about 8 carbon atoms. Illustrative non-limiting examples of such alpha-olefins are propylene, 1-butene, 1-pentene, 1-hexene, 1-octene and 1-dodecene.

Preferably, the elastomers are either ethylene/alpha-olefin copolymers or ethylene/alpha-olefin/diene terpolymers. The polyene utilized in the invention generally has about 3 to about 20 carbon atoms. Preferably, the polyene has in the range of about 4 to about 20 carbon atoms, most preferably in the range of about 4 to about 15 carbon atoms. Preferably, the polyene is a diene, which can be a straight chain, branched chain, or cyclic hydrocarbon diene. Most preferably, the diene is a non conjugated diene. Examples of suitable dienes are straight chain acyclic dienes such as: 1,3-butadiene, 1,4-hexadiene and 1,6-octadiene; branched chain acyclic dienes such as: 5-methyl-1,4-hexadiene, 3,7-dimethyl-1,6-octadiene, 3,7 -dimethyl-1,7-octadiene and mixed isomers of dihydro myricene and dihydroocinene; single ring alicyclic dienes such as: 1,3-cyclopentadiene, 1,4-cyclohexadiene, 1,5-cyclooctadiene and 1,5-cyclododecadiene; and multi-ring alicyclic fused and bridged ring dienes such as: tetrahydroindene, methyl tetrahydroindene, dicylcopentadiene, bicyclo-(2,2,1)-hepta-2-5-diene; alkenyl, alkylidene, cycloalkenyl and cycloalkylidene norbornenes such as 5-methylene-2morbornene (MNB), 5-propenyl-2-norbornene, 5-isopropylidene-2-norbornene, 5-(4-cyclopentenyl)-2-norbornene, 5-cyclohexylidene-2-norbornene, and norbornene. Of the dienes typically used to prepare EPR's, the particularly preferred dienes are 1,4-hexadiene, 5-ethylidene-2-norbornene, 5-vinyllidene-2-norbornene, 5-methylene-2-norbornene and dicyclopentadiene. The especially preferred dienes are 5-ethylidene-2-norbornene and 1,4-hexadiene.

Preferably, the elastomers have a density of below 0.91, more preferably below 0.9. In preferred embodiments of the invention, the elastomer comprises metallocene EP which is an EPR or EPDM polymer or ethylene butane or ethylene octene polymers prepared with metallocene catalysts. In embodiments of the invention, the base polymer may be metallocene EP alone, metallocene EP and at least one other metallocene polymer, or metallocene EP and at least one non-metallocene polymer as described below.

Stabilizers may be added to the composite insulation. Stabilizers may be used primarily for long term stability and moisture resistance under dielectric stress, specifically dielectric constant or specific inductive capacitance (SIC). These additives act to immobilize active ions to form salts that are insoluble in water at higher temperatures such as 75° C. or 90° C. These ions are typically present in the ppm level and exist as impurities within various additives used within this embodiment. Examples of stabilizers include lead stabilizer additives, such as dibasic lead phthalate and red lead. A non-lead example is hydrotalcite. Dibasic lead phthalate is the preferred stabilizer.

Antioxidants may be added to the insulation composite to prevent oxidative degradation of the polymers. Antioxidants, such as hydroquinones, hindered-phenols, phosphites, thioesters, epoxies, and aromatic amines, may be used. The preferred antidoxidants used in wire and cable are hydroquinones and/or hindered-phenols. A common hydroquinone is 1,2dihydro-2,2,4trimethyl quinoline. Examples of hindered-phenols are distearyl 3,3′thio-dipropionate (DSTDP), bis(2,4di terbutyl)pentaerythritol diphosphite, tris(2,4di-terbutyl)pentaerythritol diphosphite, tris(2,4di-terbutyl phenyl)phosphite, zinc 2-mercaptotoluimidazole salt, 2,2′thiodiethyl bis-(2,5-diterbutyl-4hydroxyphenyl, 2,2′-thiobis-(6 terbutyl paracresol) and dilauryl 3,3′thio-dipropionate.

The polyolefin compositions can be vulcanized using traditional curing procedures, such as chemical, thermal, moisture, room temperature vulcanization (RTV) and radiation procedures. The curing agents employed in the present invention can be organic peroxides, dicumyl peroxide and bis(terbutylperoxy)diisopropylbenzene. The peroxides act by decomposing at the cure temperature to form free radicals which then abstract a hydrogen from adjacent polymer molecules allowing the polymers to bond covalently to each other. To select the curing agents it is necessary to take into account the decomposition temperatures of the agents, in order to avoid undesirable problems during the mixture and extrusion processes. The curing agent amounts and/or ratios to be used will be defined based on the type of application because depending on the increase of the curing agent content in the formula, the following properties will be improved and/or reduced.

The composite insulation of the present invention may include other flame retardants, such as halogenated additives (compounds based on fluorine, chlorine or bromine) or halogenated polymers, such as chlorosulfonated polyethylene, neoprene, polyvinyl chloride, or the like. Effervescents, for example a combination of poly(ethylene-co-acrylate), chalk and silicone elastomer. Silicon or silicon containing flame retardants. Phosphorus Phospate esters containing flame retardants. The compositions may include other flame suppressants inorganic hydrated metal oxide such as Alumina trihydrate or Magnesium hydroxide. Synergists such as Antimony oxide or ammonium phosphate may be used. Other smoke suppressants such as Zinc borate, Barium borate, Zinc stannate, Zinc sulfide or copper salts may be used. Advantageously the micro oxide particles of the invention can lower the amounts of these additives necessary or increase flame redundancy in combination with these additives.

Mixing can be done by any method well know in the art including by internal mixers, twin screw extruders, kneaders, ribbon blenders, hi shear blade mixers and the like or even at the cable making extruders. A master batch can also first be made and let down by further mixing or used at the cable making extruder.

The composite material is then taken to an extruder. The material is fed through a hopper and carried down the length of a screw in the extruder, and forced through a crosshead die. At the same time, a conductor passes through the crosshead die where the molten coating material is applied around the conductor. This wire then goes through a cooling process, or if cross linking is desired a continuous vulcanization steam tube. At the end of the tube, the wire is reeled off and packaged.

In the case of multiconductor cable, a second insulated conductor is stranded or braided on to the reeled off wire. The cable is then passed through the crosshead die a second time where the outer coating is applied it can be vulcanized if desired.

### Testing (Drip)

The composite insulation of the present invention also provides improved dripping characteristics as demonstrated by the following testing of Standard 25 MFi 2.15 S.G. FEP produced by Daikin Industries, Ltd. Osaka Japan insulated cable comparative example versus FEP with 15% SIDISTAR® T 120 insulated cable example of the invention 1. The testing procedure includes the following steps:
1. A six inch piece of Category 5e cable, manufactured to DS-7294, jacketed with PVC plenum compound VP-7 103 and insulated with FEP was suspended approximately 3 inches above a Bunsen burner. This placed the end of the cable in the highest heat area of the flame cone.
2. The Bunsen burner was ignited and a stop watch was begun simultaneously until the first drip was observed and recorded.
3. In addition, the total number of drips during a 2 minute period was recorded.
4. This test was repeated on a six inch piece of Category 5e cable, manufactured to the same specification and using the same jacketing compound. The only difference is this cable was insulated with the FEP/15% SIDISTAR compound.
5. The test was repeated a minimum of five times for each of the two types of samples.

The results are as follows showing that the composite insulation did not drip during a two minute test period:

Results:

| | | |
|---|---|---|
| | | Total # of Drips in 2 |
| Trial # | Time to First Drip | minutes |

FEP Insulated

| | | |
|---|---|---|
| 1 | 0:47 | 39 |
| 2 | 0:54 | 28 |
| 3 | 0:59 | 20 |
| 4 | 0:46 | 37 |
| 5 | 0:42 | 35 |
| 6 | 0:44 | 33 |
| 7 | 0:42 | 43 |
| Average | 0:48 | 33.6 |

FEP/15% Sidistar Insulated

| | | |
|---|---|---|
| 1 | Never | 0 |
| 2 | Never | 0 |
| 3 | Never | 0 |
| 4 | Never | 0 |
| 5 | Never | 0 |

Conclusion: The cable insulated with the FEP/15% Sidistar compound never dripped during the two minute test period.

### Testing (Flame)

The composite insulation was flame tested according to NFPA262/ UL910 along with a comparative example like the comparative example described above with respect to the drip testing. The amount of bare conductor is measured and reported as flame spread. The composite material of the present invention showed lower flame spread and lower smoke generation than the comparative example.

Referring to FIG. 1, the composition insulation in accordance with exemplary embodiments of the present invention may be used for various cable components including but not limited to insulation for the conductors' insulation 120, the cable jacket 110, a separator 130, and the like. FIG. 1 shows a cable 100 in accordance with an exemplary embodiment of the present invention including a plurality of paired insulated conductors 140, the separator 130, and the surrounding jacket 110. As used herein “conductor” may be wire, for data or power, or optical fiber. The cable may include other components, such as a metallic shield which may be a braided conductor, a metallic foil, or both, and a barrier layer of insulation disposed between the conductors and the shield.

As seen in FIG. 1, the composite insulation with added micro oxide particles of the present invention is preferably used as an insulating layer 120 that insulates the individual conductors 150 of the cable with such conductors typically being twisted into a plurality of pairs, as is known in the art. Although it is preferable that the conductors are twisted together, the conductors may be linearly arranged, i.e. not twisted, either in pairs or groups. Alternatively, a pair of conductors may have intermittent segments that are twisted together. A preferred lay length for twisted conductors or segments thereof is approximately 0.050 to 12 inches.

A conductor insulated with the layer of composite insulation preferably has a dissipation factor of about 0.002 to 0.0002 at 1 GHz when the micro oxide particles, particularly silicon dioxide, are about 5% by weight of the composite, for example. Adhesion to the conductor is increased by about 1% or more than if the conductor is insulated with conventional material. Also, addition of the micro oxide particles allows the insulation to be pressure extruded unlike conventional insulated conductors.

The impedance of a twisted pair is related to several parameters including the diameter of the conductors, the center-to-center distance between the conductors, the dielectric constant of insulating layers, etc. The center-to-center distance is proportional to the thickness of the insulating layers and the dielectric constant depends in part on the properties of the insulation material. The type of micro oxide particles used in the insulating layers may be selected such that insulating layers achieve a desired effective dielectric constant. The concentration of the micro oxide particles embedded in the insulating layer may be controlled so as to control the effective dielectric constant of the resulting composite insulating layer. Accordingly, the dielectric constant may be reduced and/or tailored to meet the requirements of a particular design. Reduced dielectric constants for insulated conductors may yield higher transmission propagation speeds and have generally desirable skew characteristics. In general, it is to be appreciated that micro oxide particles may be used to tailor any characteristic of the cable, such as, but not limited to, characteristic impedance, burn characteristics, skew, crosstalk, and the like.

Moreover, it is to be appreciated that the composite insulation of the present invention may be used to insulate only a single conductor or a pair, more than one conductor or pair, or all of the pairs of the cable, e.g. a 3×1 or 2×2, etc. construction. For example, although FIG. 1 shows all of the wire pairs having insulation layers formed of the composite insulation of the present invention, only a single pair may have insulation layers formed of the composite insulation of the present invention with the remaining pairs having insulating layers formed of conventional materials, such as FEP, i.e. a 3×1 construction.

By using the composite insulation of the present invention to insulate a pair of conductors, the impedance of that conductor pair is raised by 0.5 to 10%, the mutual capacitance is lowered by 0.5 to 10%, the velocity of propagation is 0.5 to 30% lower, the difference in the magnitudes of the impedance from the average as swept across a frequency range of 1 Mhz to 2 Mhz is 0.5 to 30% more consistent, the inductance is lowered 0.5 to 10%, the conductance is increased by 0.5 to 10%, and attenuation is improved by more than 1%, as compared to a conductor pair insulated with material without the micro particles of the present invention. The differences reduce the costs of making the insulation and cable and also improve the performance of the cable.

With a plurality of pairs in the cable insulated with the composite insulation of the present invention, the amount of concentration of the micro oxide particles may vary within the pairs of conductors so that the resulting difference signal delay with the pairs is <25 ns (low skew cable). Also, the pairs may be constructed of materials which vary in dielectric constant (PVC olefins, fluoropolymers) and the concentration of silicon dioxide may be varied within the different pairs with that difference resulting in signal delay that is below about 45 ns (e.g. 3×1, 2×2 arrangement). It is preferred that the peak optical density (i.e. smoke density) is <0.5 and that the average optical density is <0.15 when tested to NFPA 262. This relates to the smoke density of the sample being burned.

Additionally, the conductors 150 of the cable may have dual or more than one layer of insulation where one layer 160 is formed using the composite insulation of the present invention and the other layer 170 is formed using either a conventional material, such as FEP, as seen in FIG. 2. FIG. 2 shows an exemplary conductor pair 140 where the outer layer 160 is preferably formed of the composite insulation of the present invention and the inner layer 170 is formed of a conventional material. The reverse may also be used. Alternatively, both layers 160 and 170 may be formed using the composite insulation of the present invention. And each layer may have the same or different amounts (percentage of concentration) of the micro oxide particles as compared to the other layer. Moreover, each layer of insulation may be formed using the same or different thermoplastic polymer.

For twisted wire pair applications, the conductors of the pairs may have the same insulation layers or different insulation layers. For example, the dual layers of one conductor of the pair may be both formed of the composite insulation or only one layer may be formed of a conventional material and the same being true of the other conductor of the pair.

The separator 130, as seen in FIG. 1, is preferably used to separate the pairs or groups of conductors, as is well known in the art. The separator 130 may be formed linearly along the length of the cable and may have any known shape, such as a cross web or a star. The separator 130 may also be formed with the composite insulation of the present invention. Preferably, the separator 130 is made of a thermoplastic with 1-50% silicon dioxide. The thermoplastic of the separator 130 may be embossed or perforated. The separator 130 may also be foamed up to 50% to reduce material cost. The separator 130 may be embedded with metallic shield segments. The separator 130 may also be formed as bunched fibrillated fibers (i.e. stuffing).

According to another embodiment of the present invention, some of the micro oxide particles of the composite insulation may have a color property. That allows the insulation to have brighter colors. Moreover, the composite insulation creates a surface that print ink will adhere to easily. That allows printing directly on the composite insulation without the need of an additional layer to protect the surface or use of a laser printer. Also, the surface of the composite insulation may be treated with a coupling agent, such as silane, stearic acid, and the like. That improves physical properties and/or allows the addition of a higher level of filler to reduce coat. The composite insulation may contain stabilizers for reducing degradation during processing.

While particular embodiments have been chosen to illustrate the invention, it will be understood by those skilled in the art that various changes and modifications can be made therein without departing from the scope of the invention as defined in the appended claims.

What is claimed is:

1. A cable, comprising:
at least a first pair of conductors;
at least one of said conductors of said first pair of conductors having at least one layer of a composite insulation surrounding said conductor, said composite insulation including insulating material and micro oxide particles adapted to provide an increase in the flame retardancy of the insulating material and an improvement in the electrical performance of the cable.

2. A cable according to claim 1, wherein
said micro oxide particles are silicon dioxide.

3. A cable according to claim 2, wherein
said silicon dioxide is at least 1% by weight of the composite insulation.

4. A cable according to claim 2, wherein
said silicon dioxide is between about 1% to 80% by weight of the composite insulation.

5. A cable according to claim 1, wherein
the micro oxide particles have a mean particle size of about 100-300 nm and a mean surface area of less than or equal to about 40 m²/g.

6. A cable according to claim 1, wherein
said insulating material is one of polyolefin, polyester, fluoropolymer, Halar, PTFE, PVC, HDPE and EVA.

7. A cable according to claim 6, wherein
said insulation material does not include a polyamide.

8. A cable according to claim 1, wherein
the dielectric constant and the limiting oxygen index of said composite insulation is about 3-30% higher than the insulation material.

9. A cable according to claim 1, wherein
the viscosity, the melt flow index, and the charring of said composite insulation is about 3-50% higher than the insulating material.

10. A cable according to claim 1, wherein
said composite insulation is about 5 to 50% foam.

11. A cable according to claim 1, further comprising
a second layer of insulation surrounding said conductor of said first pair of conductors that has the at least one layer of a composite insulation.

12. A cable according to claim 11, wherein
said second layer of insulation is formed of said composite insulation.

13. A cable according to claim 11, wherein
said at least one layer and said second layer of composite insulation have different amounts of said micro oxide particles in the respective layers.

14. A cable according to claim 11, wherein
said at least one layer of composite insulation and said second layer of insulation are formed with different thermoplastic polymers.

15. A cable according to claim 1, wherein
said conductors are twisted with a lay length of about 0.050 to 12 inches.

16. A cable according to claim 1, further comprising
a second pair of conductors, each of said conductors of said second pair of conductors having a layer formed of an insulating material.

17. A cable according to claim 16, wherein
both of the conductors of said first pair of conductors having a layer of insulation formed of said composite material,
whereby the impedance of said first pair of conductors is 0.55 to 10% higher, the mutual capacitance is 0.55 to 10% lower, the velocity of propagation is 0.5% to 30% lower, the difference in the magnitudes of the impedance from the average as swept across a frequency range of 1 MHz to 2 MHz is 0.5 to 30% more consistent, the inductance is 0.5% to 10% lower, the conductance is 0.5 to 10% higher, and attenuation is improved by more than 1%, as compared to said second pair of conductors.

18. A cable according to claim 17, wherein
the amount of micro oxide particles in the composite insulation of said first pair of conductors differs from the amount of micro oxide particles in the composite insulation of said second pair of conductors.

19. A cable according to claim 17, wherein
said first and second pairs of conductors are twisted with an overall cable lay of about 0.5 to 36 inches.

20. A cable according to claim 17, wherein
the amount of concentration of the micro oxide particles varies within the composite insulation of the first and second pairs of conductors so that the resulting difference signal delay with the pairs is <25 ns.

21. A cable according to claim 17, wherein
the composite insulation of said first and second pairs are constructed of materials which vary in dielectric constant and the concentration of the micro oxide particles is varied with in the different pairs resulting in signal delay that is below 45 ns.

22. A cable according to claim 17, wherein
the peak optical density of the cable is about less than 0.5, and the average optical density of the cable is less than 0.15 when tested to NFPA 262.

23. A cable according to claim 17, further comprising
at least one of a jacket for enclosing said first and second pairs of conductors and a separator for separating said first and second pairs of conductors, wherein at least one of said jacket and said separator is formed of said composite insulation.

24. A cable according to claim 1, wherein
said first pair of conductors are twisted together.

25. A cable according to claim 1, further comprising
said conductors are adapted for data transmission.

26. A data cable, comprising:
at least a first pair of conductors, said first pair of conductors being twisted together;
at least one of said conductors of said first pair of conductors having at least one layer of a composite insulation surrounding said conductor, said composite insulation including insulating material and micro oxide particles adapted to provide an increase in the flame retardancy of the insulating material and an improvement in the electrical performance of the cable.
